(19) United States
(12) Patent Application Publication
(10) Pub. No.: US 2014/0298382 A1
(43) Pub. Date: Oct. 2, 2014

(54) SERVER AND METHOD FOR TRANSMITTING AUGMENTED REALITY OBJECT

(71) Applicant: INTELLECTUAL DISCOVERY CO., LTD., Seoul (KR)

(72) Inventors: Geun Sik JO, Incheon (KR); Kee Sung LEE, Seoul (KR)

(73) Assignee: INTELLECTUAL DISCOVERY CO., LTD., Seoul (KR)

(21) Appl. No.: 14/230,305

(22) Filed: Mar. 31, 2014

(30) Foreign Application Priority Data
Mar. 29, 2013 (KR) 10-2013-0034825

(51) Int. Cl. H04N 5/445; H04N 21/41; H04N 21/472; H04N 21/4788; H04N 21/21

(52) U.S. Cl. CPC H04N 5/44582; H04N 21/4788; H04N 21/21; H04N 21/472; H04N 21/4122
USPC 725/34

(57) ABSTRACT

An augmented reality object management server is provided. The server includes a device registration unit configured to store user information and information of a plurality of devices mapped with the user information, a message reception unit configured to receive, from a device of a first user, a request message requesting to share video contents and an augmented reality object with a device of a second user, a mode selection unit configured to select a first mode for transmitting both the video contents and the augmented reality object to the device of the second user, or a second mode for transmitting only the augmented reality object to the device of the second user, and a transmission unit configured to transmit the augmented reality object to the device of the second user based on the selected mode.

### CROSS-REFERENCE TO RELATED APPLICATION

This application claims the benefit of Korean Patent Application No. 10-2013-0034825, filed on Mar. 29, 2013 in the Korean Intellectual Property Office, the entire disclosures of which are incorporated herein by reference.

### BACKGROUND

1. Field

The embodiments described herein pertain generally to a server and a method for transmitting an augmented reality object to a device of a user.

2. Description of Related Art

Smart devices such as TVs and smart phones are becoming popular, and the number of users who search information by using the smart devices is gradually increasing. In addition, when users using smart devices enabling the Internet communication have doubts or questions, they immediately solve the doubts or the questions through searches. That is, easily, promptly and exactly searching information wanted by users among a variety of information on the Internet is being preferred.

Meanwhile, services for displaying contents being played through TV devices such as TVs, IPTVs and smart TVs and information associated with the contents together are being created. These services can be provided by content providers connected through networks. This reflects the demands of users who want to identify information associated with contents, in addition to viewing the contents.

However, since these services presume that content information and information about objects appearing in the contents are all transmitted to a TV device, they do not consider selection of a user or an environment of a device in an N-screen environment where one user uses and controls a multiple number of devices. Accordingly, a method for providing contents and information about objects appearing in the contents to a device in consideration of selection of a user or an environment of a device is demanded. With respect to the method for providing information about objects appearing in contents, Korean Patent Application Publication No. 2011-00118421 describes an augmentation remote control apparatus and a method for controlling an augmentation remote control apparatus.

### SUMMARY

In view of the foregoing, example embodiments provide natural interaction between smart devices and a user in an N-screen environment. Example embodiments transmit object information, which is augmented to video contents and can be interacted, in an effective form to a device of a user and display the object information thereon. Example embodiments transmit hypothetical object information to be augmented, together with video contents, to an acquaintance user in consideration of a network circumstance of a device in the N-screen environment. However, the problems sought to be solved by the present disclosure are not limited to the above description and other problems can be clearly understood by those skilled in the art from the following description.

In one example embodiment, an augmented reality object management server is provided. The server may include a device registration unit configured to store user information and information of a plurality of devices mapped with the user information, a message reception unit configured to receive, from a device of a first user, a request message requesting to share video contents and an augmented reality object with a device of a second user, a mode selection unit configured to select a first mode for transmitting both the video contents and the augmented reality object to the device of the second user, or a second mode for transmitting only the augmented reality object to the device of the second user, and a transmission unit configured to transmit the augmented reality object to the device of the second user based on the selected mode.

In another example embodiment, a method for transmitting an augmented reality object to the device of the user is provided. The method may include storing user information and information of a plurality of devices mapped with the user information, receiving, from a device of a first user, a request message requesting to share video contents and an augmented reality object with a device of a second user, selecting a first mode for transmitting both the video contents and the augmented reality object to the device of the second user, or a second mode for transmitting only the augmented reality object to the device of the second user, and transmitting the augmented reality object to the device of the second user based on the selected mode.

In accordance with the above-described example embodiments, it is possible to provide natural interaction between smart devices and a user in the N-screen environment that should assure the real time characteristic. In addition, it is possible to transmit video contents and an augmented reality object for an object appearing in the video contents in an effective form to an acquaintance user. It is possible to transmit video contents and an augmented reality object in consideration of a network circumstance of a device within the N-screen environment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration view of an augmented reality object management system in accordance with an example embodiment;

FIG. 2 is a configuration view of an augmented reality object management server illustrated in FIG. 1 in accordance with an example embodiment;

FIG. 3A to FIG. 3D show interface in a device of a first user in accordance with an example embodiment;

FIG. 4A and FIG. 4B show results of receiving a message in a device of a second user in accordance with another example embodiment;

FIG. 5A and FIG. 5B show interface in a device of a second user;

FIG. 6 shows a first mode in accordance with an example embodiment;

FIG. 7 shows a second mode in accordance with an example embodiment;

FIG. 8 shows a detected outline in accordance with an example embodiment;

FIG. 9 shows a process, in which data are transmitted among the elements of FIG. 1, in accordance with an example embodiment;

FIG. 10 is a flow chart showing a method for providing an augmented reality object for interaction in accordance with an example embodiment; and

FIG. 11 is an operation flow chart showing a process for transmitting an augmented reality object in accordance with an example embodiment.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the term “comprises or includes” and/or “comprising or including” used in the document means that one or more other components, steps, operations, and/or the existence or addition of elements are not excluded in addition to the described components, steps, operations and/or elements.

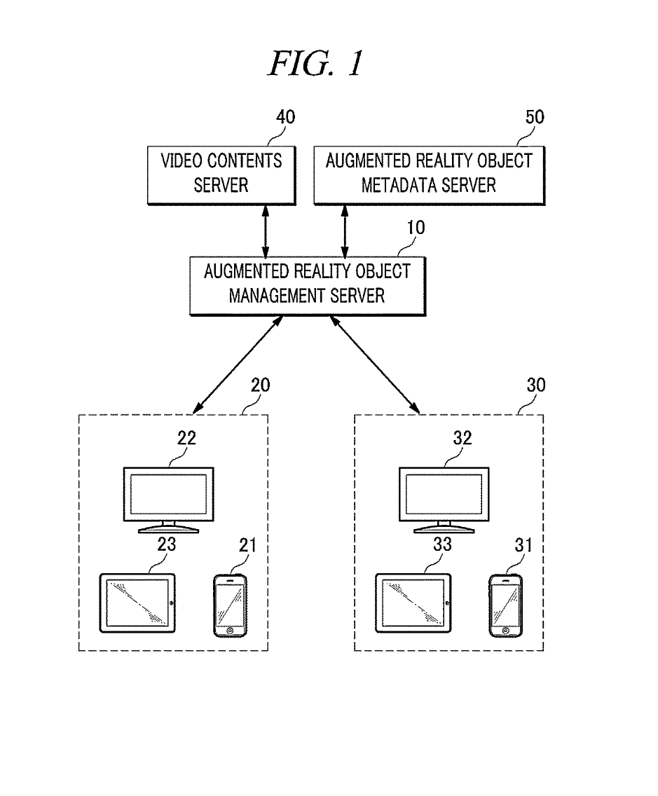

FIG. 1 is a configuration view of an augmented reality object management system in accordance with an example embodiment. With reference to FIG. 1, the augmented reality object management system includes a video content server 40, an augmented reality object metadata server 50, an augmented reality object management server 10 and devices 20 of a first user and devices 30 of a second user, which are connected to the augmented reality object management server 10 through a network.

The elements of the augmented reality object management system of FIG. 1 are generally connected to one another through a network. The network means a connection structure, which enables information exchange between nodes such as terminals and servers. Examples for the network include the 3rd Generation Partnership Project (3GPP) network, the Long Term Evolution (LTE) network, the World Interoperability for Microwave Access (WIMAX) network, the Internet, the Local Area Network (LAN), the Wireless Local Area Network (Wireless LAN), the Wide Area Network (WAN), the Personal Area Network (PAN), the Bluetooth network, the satellite broadcasting network, the analog broadcasting network, the Digital Multimedia Broadcasting (DMB) network and so on but are not limited thereto.

The video content server 40 includes a multiple number of video contents, and may transmit the video contents to the devices 20 of the first user or the devices 30 of the second user. The video content server 40 may include service providers such as You-Tube, Google TV and Apple TV, and further include content providers providing users with videos, VODs and others. However, the video content server 40 is not limited to those enumerated above.

The augmented reality object metadata server 50 may include an augmented reality object, which is augmented information in association with an object appearing in video contents. In this case, the augmented reality object is object information, which can be interacted between an object appearing on video contents and a user. Such an augmented reality object may be in the form of 2D images, 3D images, videos, texts or others, and the augmented reality object metadata server 50 may present and store an augmented reality object in a semantic form.

The devices 20 of the first user and the devices 30 of the second user may be realized as mobile terminals, which can be accessed to a remote server through a network. Here, the mobile devices are mobile communication devices assuring portability and mobility and may include, for example, any types of handheld-based wireless communication devices such as personal communication systems (PCSs), global systems for mobile communication (GSM), personal digital cellulars (PDCs), personal handyphone systems (PHSs), personal digital assistants (PDAs), international mobile telecommunication (IMT)-2000, code division multiple access (CDMA)-2000, W-code division multiple access (W-CDMA), wireless broadband Internet (Wibro) terminals and smart phones, smart pads, tablet PCs and so on. In addition, the devices 20 of the first user and the devices 30 of the second user may further include TVs, smart TVs, IPTVs, monitor devices connected to PCs, and so on, which display broadcasting videos and advertisement videos.

However, the types of the devices 20 of the first user and the devices 30 of the second user illustrated in FIG. 1 are merely illustrative for convenience in description, and types and forms of the devices 20 of the first user and the devices 30 of the second user described in this document are not limited to those illustrated in FIG. 1.

The augmented reality object management server 10 may store user information and information of multiple devices mapped with the user information. For example, a user may register multiple devices that he/she possesses and can control in the augmented reality object management server 10, and the augmented reality object management server 10 may store information of the user and information of the multiple devices that the user has registered. In this case, the information of the devices to be stored may be images, manufacturers, model codes, current locations, etc., of the devices.

The augmented reality object management server 10 may receive, from the devices 20 of the first user, a request message requesting to share video contents and an augmented reality object with the devices 30 of the second user. For example, the augmented reality object management server 10 may receive, from a smart phone, which is a first device 21 of the devices 20 of the first user, a message requesting to share information about shoes, which is one object appearing in video contents being reproduced through the smart phone, with the devices 30 of the second user.

The augmented reality object management server 10 may select one mode for transmitting video contents and an augmented reality object to the devices 30 of the second user. Here, the selected mode may be a first mode for transmitting both video contents and an augmented reality object to the devices 30 of the second user, or a second mode for transmitting only an augmented reality object to the devices 30 of the second user.

The augmented reality object management server 10 may transmit an augmented reality object to the devices 30 of the second user based on the selected mode. For example, the augmented reality object management server 10 may transmit an augmented reality object to a first device 31 of the devices 30 of the second user based on the message requesting to share the information about shoes appearing in video contents as received from the first device 21 of the first user, and the selected mode.

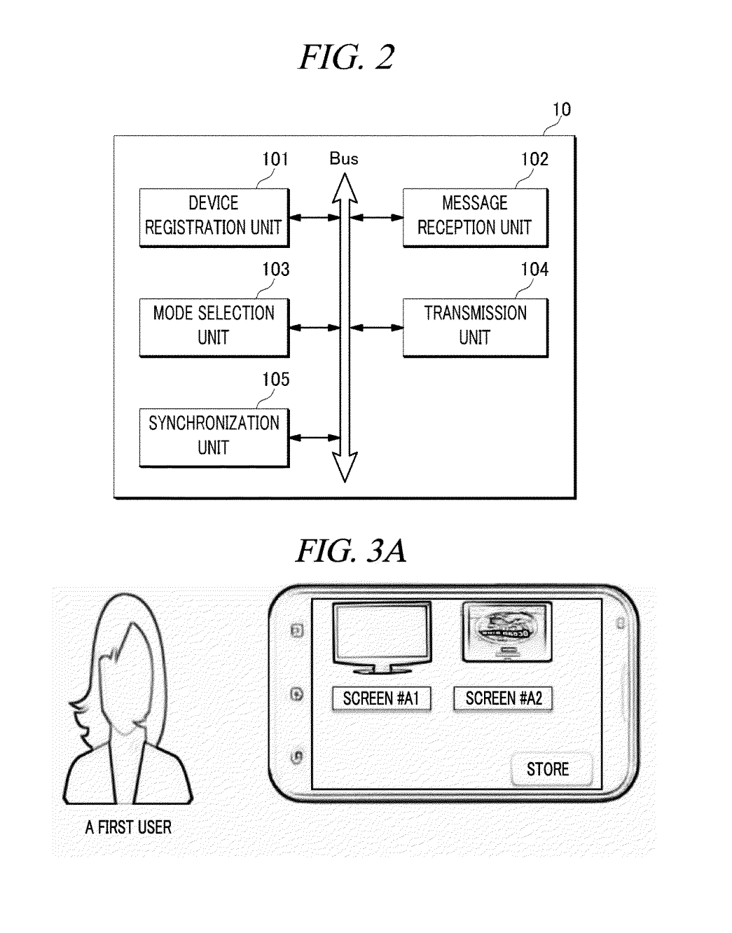

The operation of the augmented reality object management server 10 is described in detail with reference to FIG. 2.

FIG. 2 is a configuration view of the augmented reality object management server 10 illustrated in FIG. 1. The augmented reality object management server 10 includes a device registration unit 101, a message reception unit 102, a mode selection unit 103, a transmission unit 104 and a synchronization unit 105. However, the augmented reality object management server 10 illustrated in FIG. 2 is merely one example embodiment and may be variously modified based on the elements illustrated in FIG. 2. In other words, in accordance with various example embodiments, the augmented reality object management server 10 may have different configuration from that in FIG. 2.

The device registration unit 101 stores user information and information of multiple devices mapped with the user information. For example, the first and second users may request registration of devices that they can control, and the device registration unit 101 may register and store user information, manufacturers, model codes, current locations, etc., of the devices. In another example embodiment, the device registration unit 101 may receive, from a smart phone, which can include global positioning system (GPS) information among the devices 20 of the first user, a request for registration of a smart TV, including a photo of the smart TV, which has been taken through a camera device attached to the smart phone. The request for registration may further include information about a model code, a manufacturing company, and current location of the corresponding device.

The message reception unit 102 receives, from the devices 20 of the first user, a request message requesting to share video contents and an augmented reality object with the devices 30 of the second user. For example, the message reception unit 102 may receive, from a first device 21 of the first user, a request message requesting to share augmented reality object information about shoes appearing in a skateboarding video, which is being viewed by the first user through the first device 21, with the devices 30 of the second user present in a social network of the first user. The request message may further include a certain zone of the video being currently reproduced and including hypothetical augmented reality object information. Also, the request message may further include metadata of the video contents, which show information of the video contents, and metadata of the augmented reality object.

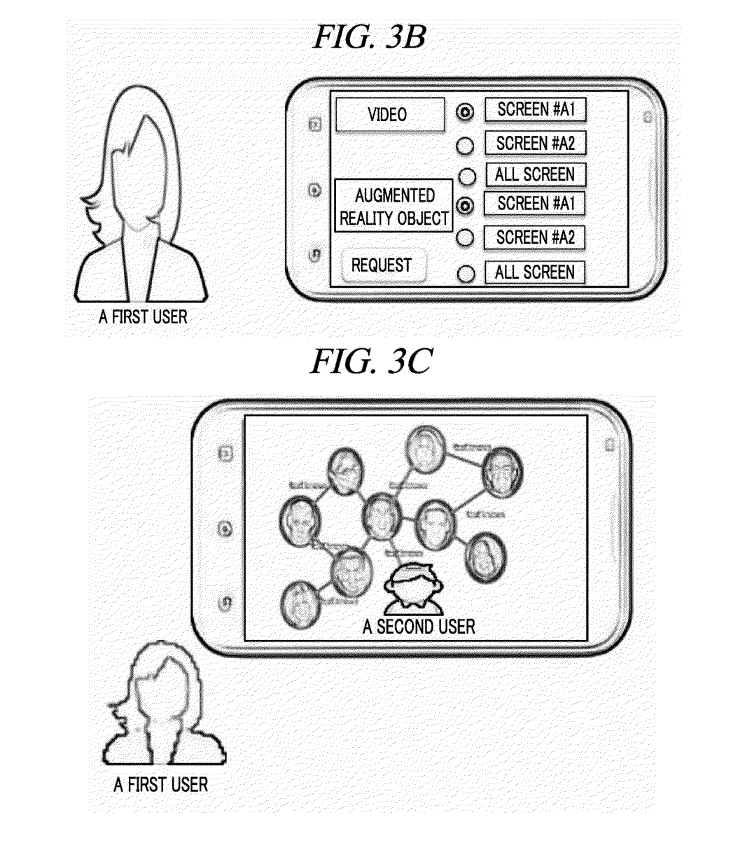

Hereinafter, an example where the message reception unit 102 receives a request message from the devices 20 of the first user is described in more detail with reference to FIG. 3A to FIG. 3D. FIG. 3A to FIG. 3D show interface in the devices 20 of the first user in accordance with an example embodiment.

With reference to FIG. 3A, while viewing video contents through a smart TV (Screen #A1) registered in the device registration unit 101, the first user may request that an augmented reality object be displayed together in order to identify information of an object appearing in the video contents. With reference to FIG. 3B, it may be requested that video contents and an augmented reality object be displayed on the smart TV or a smart phone (Screen #A2) based on selection of the first user, or video contents be played in the smart TV, and an augmented reality object be displayed on the smart phone. In this case, the message reception unit 102 may receive the request message from the smart phone of the first user.

With reference to FIG. 3C, the first user may identify an augmented reality object appearing in the video contents being played through the smart TV, and select a second user present in his/her social network in order to share the augmented reality object. In this case, in order to identify the selected second user, information enabling identification the user such as ID for the social network service, e-mail, and a phone number may be used.

With reference to FIG. 3D, the first user may set a certain zone of video contents being currently viewed and including information about an augmented reality object and request to the augmented reality object management server 10 to share the video contents with the second user present in the social network of the first user by using the smart phone of the first user, and the message reception unit 102 may receive the request message requesting to share the video contents and the augmented reality object from the smart phone of the first user. In this case, the first user may request to share both the video contents and the augmented reality object, or to share only the augmented reality object through the smart phone of the first user. The augmented reality object may be transmitted in a snapshot form, and the certain zone of the video contents may be entire zones of the video contents or a partial zone thereof, in which the augmented reality object appears.

The mode selection unit 103 selects any one of a first mode for transmitting both video contents and an augmented reality object to the devices 30 of the second user and a second mode for transmitting only an augmented reality object to the devices 30 of the second user. In this case, the mode selection unit 103 may select any one of the modes based on network information between the augmented reality object management server 10 and the devices 30 of the second user. The network information may be any one of the 3G network, the long term evolution (LTE) network and the Wi-Fi network, but is not limited thereto.

For example, the mode selection unit 103 may select the first mode for transmitting both video contents and an augmented reality object where a usable bandwidth in the network of the devices 30 of the second user is a certain value or higher, or the second mode for transmitting only an augmented reality object where the usable bandwidth in the network in the devices 30 of the second user is a certain value or less. In other words, the mode selection unit 103 may select the first mode where the devices 30 of the second user are accessed to a wired network or the Wi-Fi network, or the second mode where the devices 30 of the second user are accessed to the 3G or LTE network.

The mode selection unit 103 may select any one of the modes based on selection received from the devices 30 of the second user.

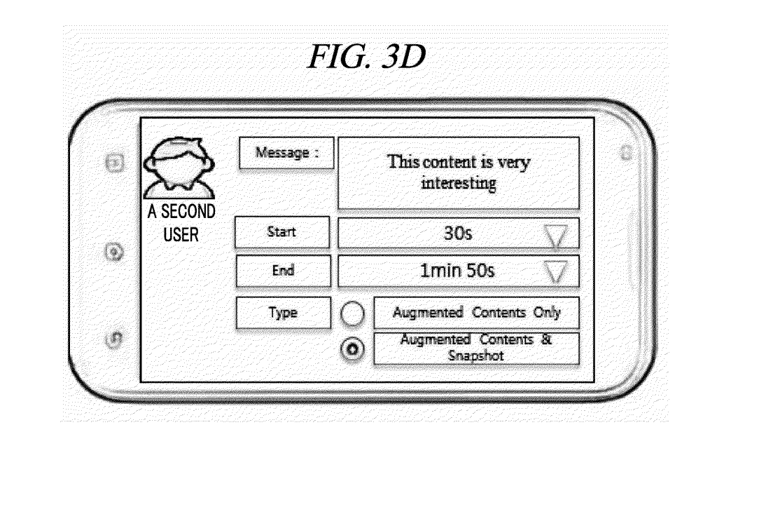

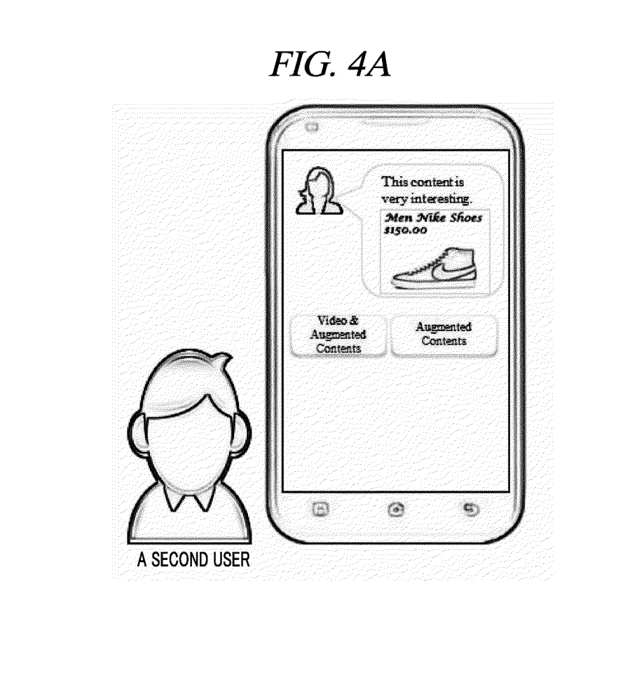

Hereinafter, an example where the mode selection unit 103 selects any one of the modes based on selection received from the devices 30 of the second user is described in more detail with reference to FIG. 4A and FIG. 4B and FIG. 5A and FIG. 5B.

FIG. 4A and FIG. 4B show results of receiving a message in the devices of the second user in accordance with an example embodiment. FIG. 5A and FIG. 5B show interface in the devices 30 of the second user in accordance with an example embodiment.

FIG. 4A shows a message transmitted to the smart phone of the second user through the augmented reality object management server 10 based on the request message requesting to share both video contents and an augmented reality object as received from the devices 20 of the first user. With reference to FIG. 4A, the message transmitted to the smart phone of the second user may include the message, the video contents and the augmented reality object from the first user.

Meanwhile, FIG. 4B shows a message transmitted to the smart phone of the second user through the augmented reality object management server 10 based on the request message requesting to share only an augmented reality object as received from the devices 20 of the first user. With reference to FIG. 4B, the message transmitted to the smart phone of the second user may include only the message and the information of the augmented reality object from the first user.

FIG. 5A shows an example, in which where displaying both video contents and an augmented reality object is selected through the smart phone of the second user, the mode selected by the smart phone of the second user is received. With reference to FIG. 5A, the mode selection unit 103 may select the first or second mode based on the selection information received from the smart phone of the second user with regard to a device, which will play video contents, and a device, which will display an augmented reality object.

Meanwhile, FIG. 5B shows an example, in which where displaying only an augmented reality object is selected through the smart phone of the second user, the mode selected by the smart phone of the second user is received. With reference to FIG. 5B, the mode selection unit 103 may select the first or second mode based on the selection information received from the smart phone of the second user with regard to a device, which will display video contents.

The transmission unit 104 transmits an augmented reality object to the devices 30 of the second user based on the selected mode. For example, where the mode selection unit 103 selects the first mode, the transmission unit 104 may transmit both video contents and an augmented reality object to the first device 31 of the second user, and where the mode selection unit 103 selects the second mode, the transmission unit 104 may transmit an augmented reality object to the first device 31 of the second user and video contents to a second device 32 of the second user.

In addition, the transmission unit 104 may search video contents from the video content server based on metadata of the video contents, and transmit the searched video contents to the devices 30 of the second user. The transmission unit 104 may search an augmented reality object from the augmented reality object metadata server 50 based on metadata of the augmented reality object, and transmit the searched augmented reality object to the devices 30 of the second user.

For example, where the mode selection unit 103 selects the first mode, the transmission unit 104 may acquire information of the smart phone of the second user based on the information of the devices 30 of the second user stored in the device registration unit 101. In addition, the transmission unit 104 may search the corresponding video contents from the video content server 40 based on metadata of the video contents, and search the corresponding augmented reality object from the augmented reality object metadata server 50 based on metadata of the augmented reality object. In this case, the searching of the video contents and the augmented reality object may be conducted based on the metadata of the video contents and the metadata of the augmented reality object contained in the request message received through the smart phone of the first user. The transmission unit 104 may transmit the searched video contents and augmented reality object to the smart phone, which is the first device 31 of the second user.

Meanwhile, where the mode selection unit 103 selects the second mode, the transmission unit 104 may acquire information of the smart phone and information of a smart TV of the second user based on the information of the devices 30 of the second user stored in the device registration unit 101. In addition, the transmission unit 104 may search video contents and an augmented reality object based on the request message received through the smart phone of the first user. The transmission unit 104 may transmit the searched augmented reality object to the smart phone, which is the first device 31 of the second user, and the searched video contents to the smart TV, which is the second device 32 of the second user.

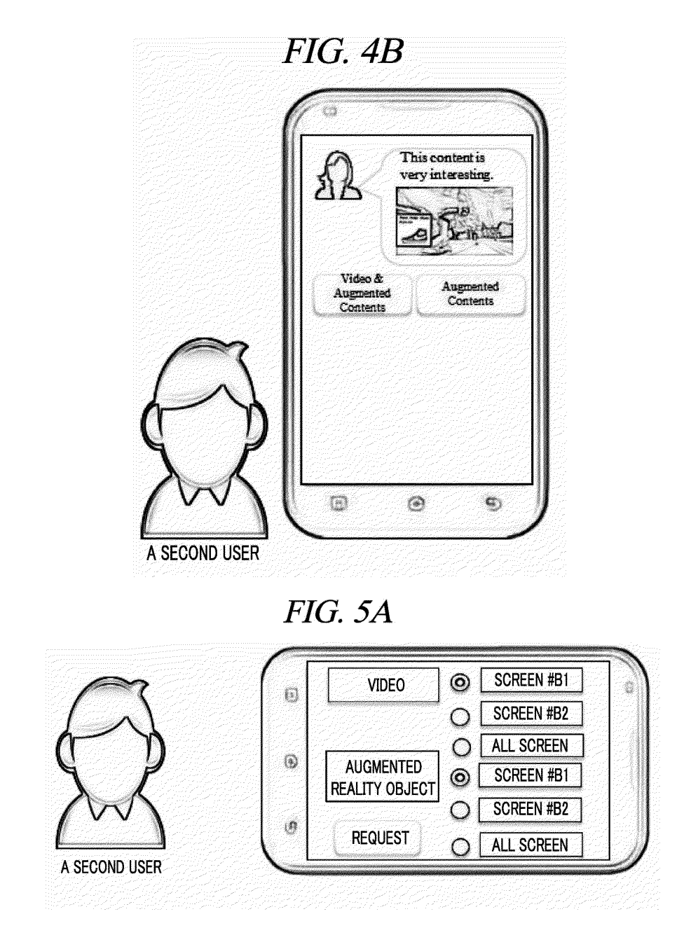

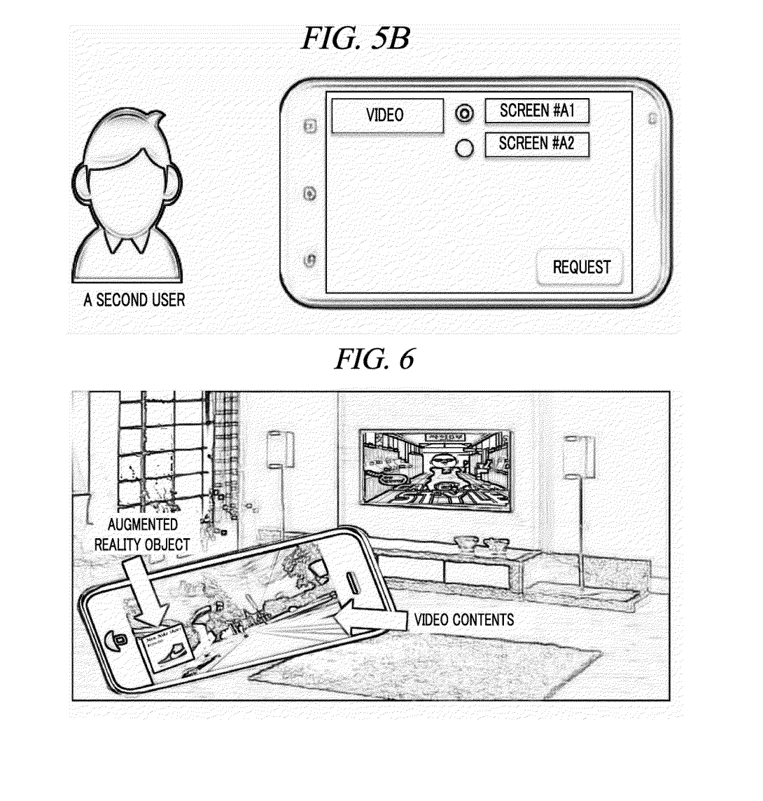

Hereinafter, an example, in which the transmission unit 104 transmits video contents and an augmented reality object depending on the modes, is described in more detail with reference to FIG. 6 and FIG. 7.

FIG. 6 shows the first mode in accordance with an example embodiment. With reference to FIG. 6, where the mode selection unit 103 selects the first mode, the transmission unit 104 may transmit both video contents and an augmented reality object to the smart phone of the second user. In this case, the smart phone of the second user may play video contents and display an augmented reality object appearing the video contents based on the video contents and the augmented reality object received from the transmission unit 104.

FIG. 7 shows the second mode in accordance with an example embodiment. With reference to FIG. 7, where the mode selection unit 103 selects the second mode, the transmission unit 104 may transmit an augmented reality object to the smart phone of the second user, and video contents to the smart TV of the second user. In this case, the smart TV of the second user may play the received video contents, and the smart phone of the second user may display a hypothetical object mapped with the video contents by photographing the smart TV, in which the video contents are being currently played, through a camera device connected to the smart phone of the second user.

The augmented reality object transmitted from the transmission unit 104 may be displayed on a part of the devices 30 of the second user, or the augmented reality object and detailed information of the augmented reality object may be briefly displayed. In addition, the augmented reality object and location of the augmented reality object may be displayed on video contents being played in the devices 30 of the second user, or the augmented reality object may be displayed directly on video contents. Meanwhile, only the augmented reality object that has been selected by the user can be displayed on the devices 30 of the second user, and may be displayed in the manner that the screen of the first device is divided such that the screen of the video contents is not blocked. Besides, the augmented reality object may not appear in the smart TV and may be displayed on the user's smart phone synchronized with the smart TV. However, the method for displaying an augmented reality object on the devices 30 of the second user is not limited to those described above.

The synchronization unit 105 may implement synchronization between the augmented reality object transmitted to the first device 31 of the second user and the video contents transmitted to the second device 32 of the second user. The synchronization unit 105 may implement synchronization between the video contents and the augmented reality object, which have been transmitted to the first device 31 of the second user.

For example, the synchronization unit 105 may implement synchronization between video contents and an augmented reality object based on current time or frame information of the video contents being currently played. In other words, the synchronization unit 105 may synchronize video contents being currently played and metadata of an augmented reality object so that as the video contents are played, the augmented reality object can also move together.

The synchronization unit 105 may calculate a relative position to a currently extracted TV area by using a TV area extracted in real time and a relative coordinate value for metadata of an augmented reality object, and display the augmented reality object in the corresponding area.

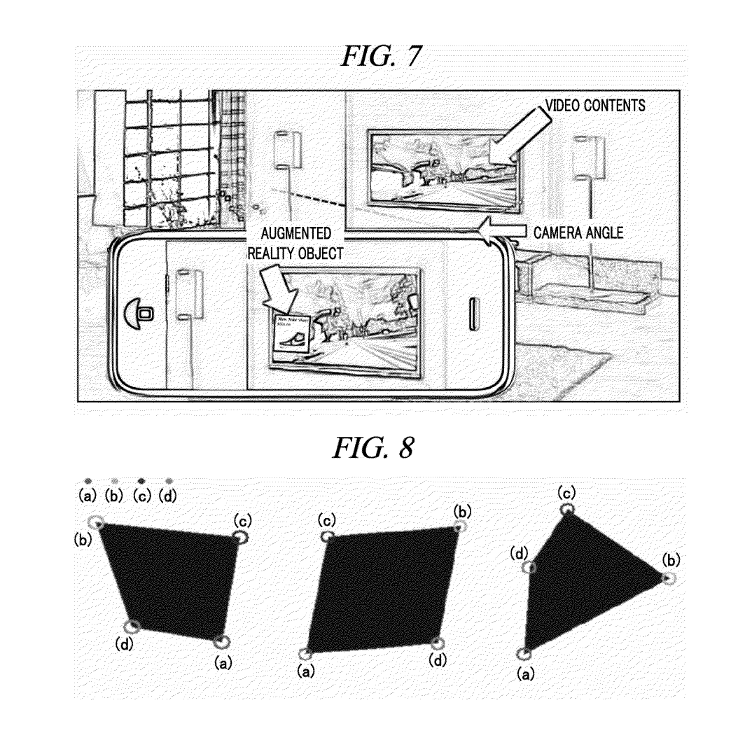

Hereinafter, an example, in which a TV area is extracted in real time, and an augmented reality object is displayed on the corresponding area, is described with reference to FIG. 8.

FIG. 8 shows a detected outline in accordance with an example embodiment. With reference to FIG. 8, for example, the smart TV, in which video contents are being currently played, may be photographed through the camera device of the smart phone of the second user. In this case, the smart phone of the second user may detect an outline from the images photographed through the camera device, detect angular points for a TV area, and extract a TV area from a combination, in which the sum of triangles is the largest.

The outline provides location, a shape, a size and texture information of an object within a photographed image, and may be detected by analyzing points where brightness of an image rapidly changes. The method for detecting the outline uses a method of deducting each of neighboring 8 pixels from a center pixel to select the highest value from absolute values for the differences.

In order to find out 4 angular points forming a square, a point, which is the most distant from a firstly detected point of pixels (points) forming the outline, may be determined as a first angular point, and a point, which is the most distant from the firstly determined angular point, may be determined as a second angular point. Among the pixels forming the outline, a point, which is the most distant from the first and second angular points, may be determined as a third angular point, and a point, which corresponds to the case where a certain square produced by using the pixels forming the outline and the three angular points is divided into three triangles, and the sum of the areas of the triangles is the largest, may be determined as a fourth angular point. The smart phone of the second user may detect a TV area on an image by connecting the determined 4 (four) angular points. Where a multiple number of TV areas are detected, the corresponding TV area may be determined by selection of the user.

The synchronization unit 105 may synchronize the TV area determined on the image photographed through the camera device of the smart phone of the second user and the augmented reality object.

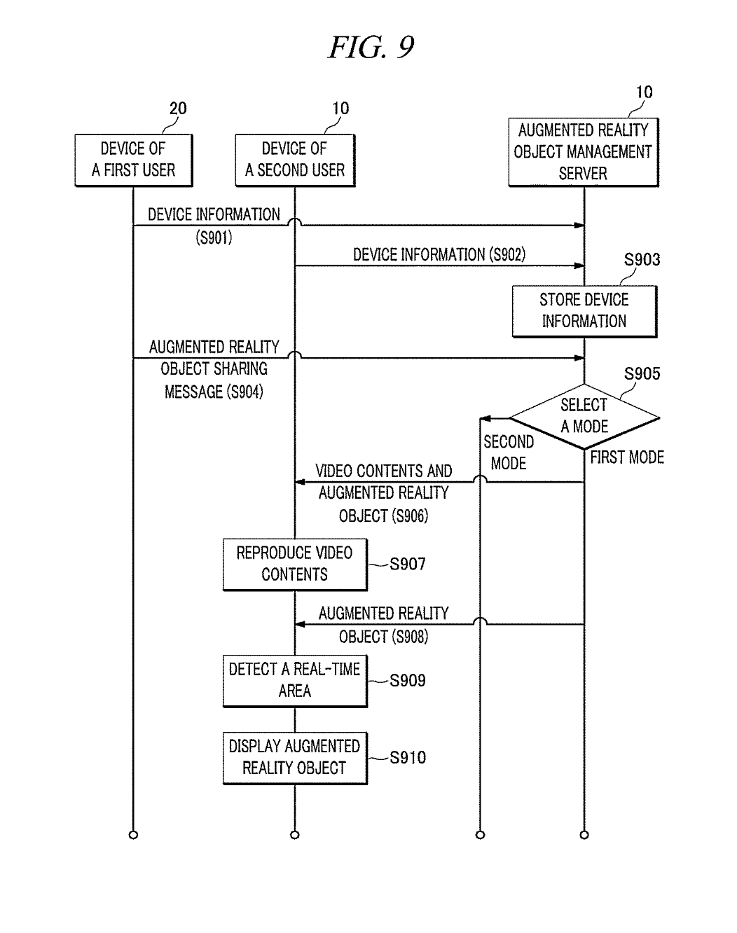

FIG. 9 shows a process, in which data are transmitted among the elements of FIG. 1, in accordance with an example embodiment. With reference to FIG. 9, the augmented reality object management server 10 receives information of at least one device that can be controlled by the first user from the devices 20 of the first user (S901), and information of at least one device that can be controlled by the second user from the devices 30 of the second user (S902). The augmented reality object management server 10 stores the received device information (S903).

Thereafter, the augmented reality object management server 10 receives an augmented reality object sharing message requesting to share an augmented reality object mapped with video contents being currently played from the devices 20 of the first user (S904), and determines a mode depending on a network circumstance of the second user based on the received sharing message (S905). Where the first mode is determined, the augmented reality object management server 10 transmits both vide contents and an augmented reality object to the first device 31 among the devices 30 of the second device (S906), and the first device 31 of the second user plays the video contents, and simultaneously, displays the augmented reality object synchronized with the video contents (S907). Where the second mode is determined, the augmented reality object management server 10 transmits an augmented reality object to the first device 31 of the second user (S908), and video contents to the second device 32 of the second user. The first device 31 of the second user photographs the second device 32 through its camera device to detect an area of the second device 32 in real time (S909), and displays the augmented reality object based on the detected area (S910).

However, the present disclosure is not limited to the example embodiment illustrated in FIG. 9, and there may be other various example embodiments.

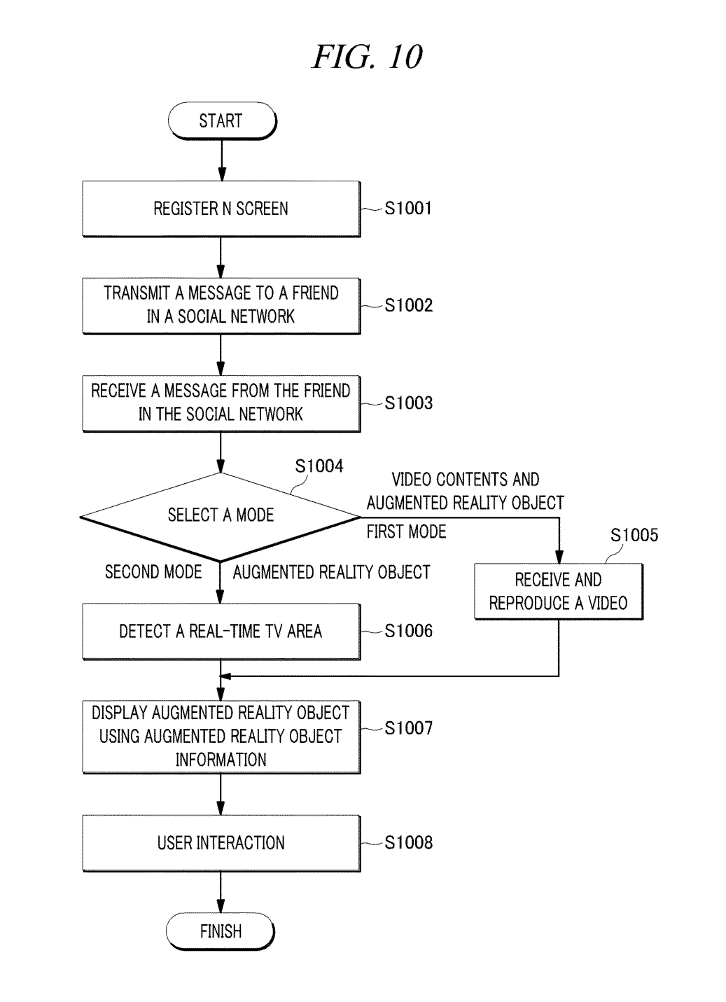

FIG. 10 is a flow chart showing a method for providing an augmented reality object for interaction in accordance with an example embodiment. With reference to FIG. 10, the augmented reality object management server 10 registers a multiple number of devices that can be controlled by a user in the N-screen environment (S1001). Thereafter, the first user transmits a message regarding sharing an augmented reality object with the second user, which is a friend in the social network, to the augmented reality object management server through the devices 20 of the first user (S1002). The augmented reality object management server 10 receives the message regarding the sharing from the first user in the social network (S1003), and determines a mode based on the received message (S1004).

Based on the determined mode, the augmented reality object management server 10 transmits video contents and an augmented reality object to the first device 31 of the second user or transmits an augmented reality object to the first device 31 of the second user and video contents to the second device 32 of the second user. Where video contents and an augmented reality object are transmitted to the first device 31 of the second user, the video contents are received and played through the first device 31 (S1005).

Meanwhile, where only an augmented reality object is transmitted to the first device 31 of the second user, the first device 31 detects an area of the second device 31, which is a real-time TV area, through the camera device (S1006). The augmented reality object management server 10 may display a virtual augmented reality object using augmented reality information on a certain position of the video contents (S1007), and when the area of the second device 32 is detected, the augmented reality object management server 10 may calculate a relative position to the detected area to display the augmented reality object. Thereafter, the first device 31 of the second user may receive input of user interaction (S1008).

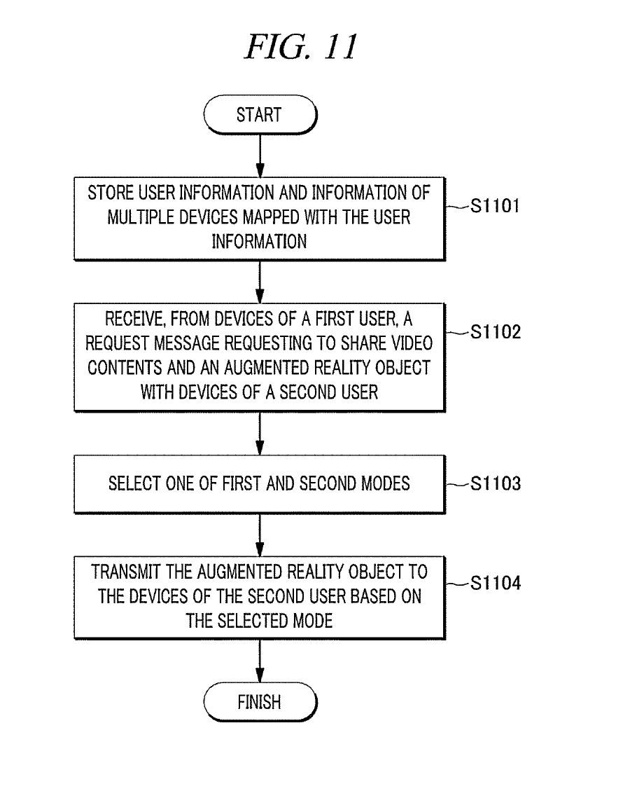

FIG. 11 is an operation flow chart showing a process for transmitting an augmented reality object, in accordance with an example embodiment. The method for transmitting an augmented reality object in accordance with an example embodiment as illustrated in FIG. 11 includes the sequential processes implemented in the augmented reality object management server 10 illustrated in FIG. 2. Accordingly, the descriptions of the augmented reality object management server 10 with reference to FIG. 1 to FIG. 8 are also applied to FIG. 11 though are not omitted hereinafter.

With reference to FIG. 11, the augmented reality object management server 10 stores user information and information of multiple devices mapped with the user information (S1101). Thereafter, the augmented reality object management server 10 receives, from the devices 20 of the first user, a request message requesting to share video contents and an augmented reality object with the devices of the second user (S1102), and based on the received request message, any one of the first mode for transmitting both the video contents and the augmented reality object to the devices 30 of the second user, and the second mode for transmitting only the augmented reality object to the devices 30 of the second user is selected (S1103). Based on the determined mode, the augmented reality object management server 10 transmits the augmented reality object to the devices 30 of the second user (S1104).

In this case, where the first mode is selected, the augmented reality object management server 10 transmits both the video contents and the augmented reality object to the first device 31 of the second user, and where the second mode is selected, the augmented reality object management server 10 transmits the augmented reality object to the first device 31 of the second user, and the video contents to the second device 32 of the second user. In addition, the augmented reality object management server may implement synchronization between the video contents and the augmented reality object.

The augmented reality object transmitting method described with reference to FIG. 11 can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

### EXPLANATION OF CODES

10: Augmented reality object management server

20: Device of a first user

30: Device of a second user

31: First device of the second user

32: Second user of the second user

40: Video content server

50: Augmented reality object metadata server

What is claimed is:

1. An augmented reality object management server, the server comprising:
a device registration unit configured to store user information and information of a plurality of devices mapped with the user information;
a message reception unit configured to receive, from a device of a first user, a request message requesting to share video contents and an augmented reality object with a device of a second user;
a mode selection unit configured to select a first mode for transmitting both the video contents and the augmented reality object to the device of the second user, or a second mode for transmitting only the augmented reality object to the device of the second user; and
a transmission unit configured to transmit the augmented reality object to the device of the second user based on the selected mode.

2. The augmented reality object management server of claim 1,
wherein the mode selection unit selects the first mode for transmitting both the video contents and the augmented reality object to a first device of the second user, or the second mode for transmitting only the augmented reality object to a first device of the second user,
where the first mode is selected, the transmission unit transmits both the video contents and the augmented reality object to the first device of the second user,
where the second modes is selected, the transmission unit transmits the augmented reality object to the first device of the second user, and the video contents to the second device of the second user.

3. The augmented reality object management server of claim 1,
wherein the mode selection unit selects any one of the modes based on the selection information received from the device of the second user.

4. The augmented reality object management server of claim 2, the server further comprising
a synchronization unit configured to perform synchronization between the augmented reality object transmitted to the first device of the second user and the video contents transmitted to the second device of the second user.

5. The augmented reality object management server of claim 1,
wherein the mode selection unit selects any one of the modes based on information of network between the augmented reality object management server and the device of the second user.

6. The augmented reality object management server of claim 5,
wherein the information of the network is information of the 3G network, information of the long term evolution (LTE) network or information of the Wi-Fi network.

7. The augmented reality object management server of claim 1,
wherein the transmission unit searches the video contents from a video content server based on metadata of the video contents, and transmits the searched video contents to the device of the second user.

8. The augmented reality object management server of claim 1,
wherein the transmission unit searches the augmented reality object from an augmented reality object metadata server based on metadata of the augmented reality object, and transmits the searched augmented reality object to the device of the second user.

9. A method for transmitting an augmented reality object to the device of the user, the method comprising:
storing user information and information of a plurality of devices mapped with the user information;
receiving, from a device of a first user, a request message requesting to share video contents and an augmented reality object with a device of a second user;
selecting a first mode for transmitting both the video contents and the augmented reality object to the device of the second user, or a second mode for transmitting only the augmented reality object to the device of the second user;
transmitting the augmented reality object to the device of the second user based on the selected mode.

10. The method for transmitting an augmented reality object of claim 9,
wherein the first mode is for transmitting both the video contents and the augmented reality object to a first device of the second user, and the second mode is for transmitting only the augmented reality object to a first device of the second user.

11. The method for transmitting an augmented reality object of claim 10,
wherein where the first mode is selected, both the video contents and the augmented reality object are transmitted to the first device of the second user, and
where the second mode is selected, the augmented reality object information is transmitted to the first device of the second user, and the video contents are transmitted to the second device of the second user.

12. The method for transmitting an augmented reality object of claim 9, the method further comprising
performing synchronization between the augmented reality object transmitted to the first device of the second user and the video contents transmitted to the second device of the second user.
